(19) United States
(12) Patent Application Publication
(10) Pub. No.: US 2003/0118904 A1
(43) Pub. Date: Jun. 26, 2003

(54) Electrode for lithium secondary battery and lithium secondary battery and method of manufacturing same

(76) Inventors: Norikazu Hosokawa, Nagoya-City (JP); Hiroshi Ueshima, Anjyo-City (JP); Satoru Suzuki, Nagoya-City (JP); Norikazu Adachi, Nagoya-City (JP); Manabu Yamada, Okazaki-City (JP)

Correspondence Address: HARNESS, DICKEY & PIERCE, P.L.C., P.O. BOX 828, BLOOMFIELD HILLS, MI, 48303, US

(21) Appl. No.: 10/321,207

(22) Filed: Dec. 17, 2002

(30) Foreign Application Priority Data
Dec. 20, 2001 (JP) 2001-387646
Oct. 21, 2002 (JP) 2002-306237

(51) Int. Cl. H01M 4/62; H01M 4/04

(52) U.S. Cl. 429/217; 29/623.1

(57) ABSTRACT

The present invention provides an electrode for a lithium secondary battery capable of achieving high power output characteristics when applied to a lithium secondary battery. The present invention relates to an electrode for a lithium secondary battery having an electrode composite material layer comprising an active material and a binder, wherein the binder \mathring{1} contains a hydrophilic binder consisting of a cellulose derivative and an electrolyte-philic binder containing polyether structure, \mathring{2} contains a block-type hydrophilic-electrolytephilic binder consisting of a cellulose derivative having grafted electrolyte-philic side chain consisting of polyether structure, or \mathring{3} has dispersed soluble dispersion that is soluble in non-aqueous electrolyte. Thus, the present invention realizes construction of an electrode composite material layer in which a portion of high lithium ion conductivity is locally formed in a part of binder covering the surface of the active material so that, even when large current is discharged or the battery is operated at low temperature, lithium ions are easy to be conducted between the active material and non-aqueous electrolyte, and cell reaction can proceed smoothly and power output characteristics can be thereby improved.

### BACKGROUND OF THE INVENTION

1. Field of the Invention

The present invention relates to an electrode for a lithium secondary battery and a lithium secondary battery and a method of manufacturing same, and more particularly to an electrode for a lithium secondary battery which is capable of being advantageously applied to a lithium secondary battery and has an excellent characteristics for discharging large current at low temperature, and to a lithium secondary battery and a method of manufacturing same.

2. Description of the Related Art

In recent years, cordless electronic equipments such as video cameras and portable telephones and the like have been developed and used extensively, and with this development, lithium secondary batteries have been attracting increasing attention because of the high battery voltage and high energy density as power sources for applications for the cordless electronic equipment, and the practical application thereof is now rapidly in progress.

Aside from applications for the cordless electronic equipment, electric cars and hybrid cars are now being developed in automobile industry with environmental concern or the like as the driving motive in the background, and lithium secondary batteries are attracting attention and are being examined as vehicle-mounted electric power sources.

A method for manufacturing a positive electrode for a conventional lithium secondary battery is known from Japanese Patent Publication No. H02-158055, in which an active powder material and conducting filler material are homogeneously mixed with a binder consisting of carboxymethyl cellulose aqueous solution and polytetrafluoroethylene aqueous dispersion solution, and the mixture is coated to a film-shaped conductive foil such as a rolled aluminium foil, dried and rolled.

When resins such as polytetrafluoroethylene and carboxymethyl cellulose which have excellent resistance to organic solvents are used as binders, they do not swell nor dissolve in organic solvents such as ethylene carbonate (EC), propylene carbonate (PC), diethyl carbonate (DEC), or the like which are used as the solvent for the non-aqueous electrolyte of the lithium secondary battery, and thus are capable of maintaining the active material in firmly bound state. Thus, they can be advantageously used to realize a good cycle property of the battery. In particular, the advantage is exhibited more distinctly when the operating temperature of the battery is high.

On the other hand, however, if the binder covers the surface of the active material and binds with it firmly, conduction of lithium ions on the surface of the active material is hindered, leading to deterioration of the battery characteristics. This effect becomes more pronounced as the operating temperature of the battery is lower and the value of the discharge current is larger.

When a lithium secondary battery is used as a vehicle-mounted electric power supply, the conditions for use are more stringent compared to applications for the cordless electronic equipment. In addition to the requirement of high energy density, not only high power output characteristics at room temperature but also high power output characteristics for a few seconds at low temperature (about −30° C.) is required in order to start an engine in a cold weather region.

### SUMMARY OF THE INVENTION

It is therefore an object of the present invention to provide a lithium secondary battery having an excellent output capacity, and thus, it is the problem to be solved by the present invention to provide an electrode for a lithium secondary battery and a method of manufacturing same capable of realizing high power output characteristics when applied to a lithium secondary battery, and to provide a lithium secondary battery having high power output characteristics and a method of manufacturing same.

The above object was attained as a result of intensive study conducted by the present inventor in which it has been found that, by forming a local region of high lithium ion conductivity in a portion of the binder covering the surface of the active material, a structure of the electrode composite material layer can be realized which permits lithium ions to be conducted easily between the active material and the non-aqueous electrolyte even when a large current is discharged or when the battery is operated at low temperature, and the cell reaction can thereby proceed smoothly and the power output characteristics can be improved. This finding leads to the present invention as described below.

Thus, an electrode for a lithium secondary battery which has an electrode composite material layer comprising an active material and a binder covering the surface of the active material, is provided in accordance with the present invention, as means broadly classified in the following three types, that is, \mathring{1} wherein the binder contains a hydrophilic binder consisting of a cellulose derivative and an electrolyte-philic binder having polyether structure in the chemical structure, or \mathring{2} wherein the binder contains a block-type hydrophilic-electrolytephilic binder consisting of a cellulose derivative having grafted electrolyte-philic side chain consisting of polyether structure, or \mathring{3} wherein the binder has dispersed a soluble dispersion that is soluble in a non-aqueous electrolyte.

In the electrode for a lithium secondary battery according to means \mathring{1}, the binder is a mixture of a hydrophilic binder consisting of a cellulose derivative that is stable to the non-aqueous electrolyte and capable of realizing a good cycle property and an elecrolyte-philic binder having polyether structure that has excellent conductivity for lithium ions so that the combined binder as a whole can form regions exhibiting high conductivity for lithium ions while having an improved adherence to the active material. As a result, the electrode provides excellent power output characteristics when applied to a lithium secondary battery.

Carboxymethyl cellulose may be mentioned as an advantageous example of the hydrophilic binder. As an advantageous example of the electrolyte-philic binder, polyethylene oxide may be mentioned.

Content of the electrolyte-philic binder relative to the electrode composite material is preferably 3 wt % or less. With the content of 3 wt % or less, function as the binder for fabricating an electrode can be adequately fulfilled, and the battery performance can be improved.

In the electrode for a lithium secondary battery according to means \mathring{2}, a hydrophilic-electrolytephilic binder is used which has hydrophilic cellulose structure and electrolyte-philic polyether structure in a same molecule so that both a hydrophilic site and an electrolyte-philic site occur in the same molecule with the hydrophilic site adhering firmly to the surface of the active material for improving cycle property and with the electrolyte-philic site providing high ionic conductivity for good power output characteristics.

A binder which has ether linkage of carboxymethyl cellulose and polyethylene oxide may be mentioned as a preferable example of a block-type hydrophilic-electrolytephilic binder.

In the electrode according to means \mathring{1} or \mathring{2}, the content of the cellulose derivative is preferably 2 wt % or less relative to the total mass of the electrode composite material.

In the electrode for a lithium secondary battery according to means \mathring{3}, a binder is used which has a soluble dispersion dispersed therein so that, when the electrode for lithium secondary battery is applied to a lithium secondary battery, the soluble dispersion is dissolved and removed in a non-aqueous electrolyte so as to form pores through which lithium ions can be conducted, and good power output characteristics can be thereby obtained.

By using lithium salt as the soluble dispersion, not only the soluble dispersion is dissolved and removed in a non-aqueous electrolyte so as to form pores, but also the binder having the lithium salt dispersed therein exhibits an action similar to a solid-electrolyte, and advantageously contributes to the conduction of lithium ions, leading to an improvement of power output characteristics.

As a lithium secondary battery which solves above described problem, a battery incorporating the electrode for lithium secondary battery according to any one of means \mathring{1} to \mathring{2} above as at least one of positive and negative electrodes, has been invented.

As a method of manufacturing a lithium secondary battery which solves above described problem, a method of manufacturing a lithium secondary battery incorporating the electrode for lithium secondary battery according to means \mathring{2} or \mathring{2} above as at least one of positive and negative electrode and comprising the step of warming up to or above a temperature at which the non-aqueous electrolyte swells or dissolves the portion of the polyether structure, has been invented.

By this step of warming up, the portion of the binder containing the polyether structure (electrolyte-philic binder in means \mathring{1}, or electrolyte-philic site in means \mathring{2}) may be more easily swollen or dissolved in the non-aqueous electrolyte and more conductive paths for lithium ions may be formed so that a lithium secondary battery having better power output characteristics can be manufactured. It is also expected that the cellulose structure as the hydrophilic binder or hydrophilic site may be swollen or dissolved by this warming-up step and conductive paths for lithium ions can be formed also in the hydrophilic binder or the like.

It has been found from experiments that the warming-up step is preferably performed after the lithium secondary battery with active inner electrodes has been charged up to or above 4.1 V., which makes inner electrodes active.

Carboxymethyl cellulose may be mentioned as a preferred example of the hydrophilic binder. Polyethylene oxide may be mentioned as a preferred example of the electrolyte-philic binder. Content of the electrolyte-philic binder relative to the total mass of the electrode composite material layer is preferably 3 wt % or less.

A binder which has ether linkage of carboxymethyl cellulose and polyethylene oxide may be mentioned as a preferred example of the block-type hydrophilic-electrolytephilic binder. Content of the cellulose derivative relative to the total mass of the electrode composite material layer is preferably 2 wt % or less.

As a method of manufacturing an electrode for a lithium secondary battery which solves the above described problem, a manufacturing method of an electrode for a lithium secondary battery comprising an electrode composite material layer forming step of forming an electrode composite material layer consisting of an active material and a binder having soluble dispersion dispersed therein and covering the surface of the active material, and a dissolving step of dissolving and removing the soluble dispersion by soaking the electrode composite material in a solvent for dissolving the soluble dispersion, has been invented.

Thus, the electrode for a lithium secondary battery containing the binder having the soluble dispersion dispersed therein is soaked in a solvent capable of dissolving the soluble dispersion to dissolve and remove the soluble dispersion. The soluble dispersion dissolved can be thereby removed out of the system of the lithium secondary battery so that freedom of selection for the soluble dispersion is remarkably increased.

Lithium salts may be employed as the soluble dispersion.

### BRIEF DESCRIPTION OF THE DRAWINGS

FIG. 1 is a view showing the construction of a cylindrical lithium secondary battery fabricated according to an example of the present invention;

FIG. 2 is a graph showing the dependency of the power at low temperature upon the amount of added CMC; and

FIG. 3 is a graph showing the dependency of the power at low temperature upon the amount of added PEO.

### DESCRIPTION OF THE PREFERRED EMBODIMENTS

(Electrode for a Lithium Secondary Battery)

An electrode for a lithium secondary battery according to the present embodiment comprises an active material and an electrode composite material layer containing a binder and capable of further containing other additives as necessary. The electrode composite material layer is in general formed on a current collector. The present electrode can be applied both as a positive electrode and as a negative electrode.

The binder that can be used in the electrode for a lithium secondary battery according to the present embodiment may be classified into following three types. The three types described in the following are not exclusive to each other and may be used in combination. The binder is preferably water-soluble or water-dispersive as a whole. A hydrophobic binder can be made water dispersive by a hydrophilicizing treatment of the surface of the binder.

Further, known binders such as PVDF, PTFE, SBR, and binders obtained by hydrophlicizing treatment thereof, as well as polyvinyl alcohol, polyacrylate, and the like, may be contained in the binder. In order to give flexibility to the electrode, a fluororesin that is difficult to react with non-aqueous electrolyte such as PTFE, FEP (tetrafluoroethylene-hexafluoropropylene copolymer), PFA (tetrafluoroethylene-perfluoroalkylvinyl ether copolymer), ETFE (tetrafluoroethylene-ethylene copolymer), EPE (tetrafluoroethylene-hexafluoropropylene perfluoroalkylvinyl ether copolymer) may be used in conjunction.

\mathring{1} Binder containing hydrophilic binder and electrolyte-philic binder as separate molecules.

The hydrophilic binder is a cellulose derivative that is insoluble in the non-aqueous electrolyte. Examples of suitable cellulose derivative include carboxymethyl cellulose (CMC), methyl cellulose (MC), cellulose acetate phthalate (CAP), hydroxypropylmethyl cellulose phthalate (HMCP), and CMC is preferably used. Content of the hydrophilic binder is preferably 2 wt % or less, and more preferably 1 wt % or less, relative to the total mass of the electrode composite material layer.

The electrolyte-philic binder is a compound which has polyether structure having higher affinity to non-aqueous electrolyte than the hydrophilic binder, and is preferably a compound which dissolves or swells in non-aqueous electrolyte at temperature higher than the operating temperature of the lithium secondary battery. Content of the electrolyte-philic binder is preferably 3 wt % or less relative to the total mass of the electrode composite material layer. Solubility to the non-aqueous electrolyte may be controlled by adjustment of molecular weight, post-processing after fabrication of the electrode for forming cross-link between molecules, or the like. Examples of suitable electrolyte-philic binder include polyethylene oxide (PEO), polypropylene oxide (PPO), polyethylene oxide-propylene oxide copolymer (PEO-PPO), and PEO is preferably used. The hydrophilic binder and the electrolyte-philic binder have preferably high compatibility with each other.

\mathring{2} Binder containing hydrophilic-electrolytephilic binder having electrolye-philic side chain bound to cellulose backbone (binder containing hydrophilic site and electrolyte-philic site in a same molecule).

A hydrophilic-electrolytephilic binder is a compound which has hydrophilic site and electrolyte-philic site in a same molecule, and which is insoluble in non-aqueous electrolyte in the operating temperature range of the lithium secondary battery. Solubility to the non-aqueous electrolyte may be controlled by adjustment of molecular weight, post-processing after fabrication of the electrode for forming cross-link between molecules, or the like. The hydrophilic site and the electrolyte-philic site preferably form a sea-island structure or lamella structure when the binder covers the surface of the active material.

Examples of the hydrophilic-electrolyte-philic binder include a compound obtained from CMC by substituting the carboxyl group with polyethylene oxide, a compound obtained from CMC by ether linkage of the carboxyl group with polyethylene oxide, hydroxyethyl cellulose (HEC), hydroxypropyl cellulose (HPC), and a compound obtained from CMC by substituting the carboxyl group with polyethylene oxide or a compound obtained from CMC by ether linkage of the carboxyl group with polyethylene oxide is preferably used.

Content of the hydrophilic site in the molecular structure of the hydrophilic-electrolyte-philic binder is preferably 2 wt % or less, and more preferably 1 wt % or less, relative to the total mass of the electrode composite material layer. Content of the electrolyte-philic site is preferably 3 wt % or less relative to the total mass of the electrode composite material layer.

\mathring{3} Binder having soluble dispersion dispersed therein.

This binder has soluble dispersion dispersed in a polymer matrix. The polymer matrix is not particularly restricted, and any polymer compound generally called as a binder may be advantageously used. From the viewpoint of cycle property, a water-soluble compound, for example, CMC, PTFE that has been processed in hydrophilicizing treatment, SBR, or the like, is preferably used as the polymer matrix.

The soluble dispersion is a compound soluble in the non-aqueous electrolyte. The influence of the soluble dispersion upon battery performance after it is dissolved in non-aqueous electrolyte can be reduced by using a lithium salt. When a water-soluble compound is used as the binder, a lithium salt which has low reactivity with water such as lithium imide salt is preferred.

A generally adopted method may be used for dispersing the soluble dispersion, for example, by evaporating a solvent after the polymer matrix dissolved in the solvent is mixed with the soluble dispersion (which may be or may not be dissolved), by contacting with a solvent that does not dissolve the soluble dispersion and the polymer matrix to deposit the binder, or by kneading the polymer matrix and the soluble dispersion under room temperature or under an elevated temperature.

Content of the soluble dispersion in the binder is preferably 50 wt % or higher relative to the total mass of the binder. Dispersion of the soluble dispersion in the binder may be accomplished in the size of the order of molecules of the soluble dispersion, of the order of crystals of the soluble dispersion, or in any size of higher order, but needs to be accomplished in such size that the binder can cover the surface of the active material in divisions of the binder and the soluble dispersion.

The active material is a compound capable of incorporating or releasing lithium ions.

The active material for the positive electrode is capable of releasing lithium ions during charging, and incorporating lithium ions during discharging. Examples of suitable active material for the positive electrode include lithium-metal complex oxide-containing active material which contains one or more of lithium-metal complex oxides having layered structure or spinel structure.

Lithium-metal complex oxide-containing active material is, for example, a material such as Li_{(1-X)}NiO₂, Li_{(1-X)}MnO₂, Li_{(1-X)}Mn₂O₄, Li_{(1-X)}CoO₂, Li_{(1-X)}FeO₂, or material obtained from them by adding or substituting Li, Al or transition metal such as Cr. Here, X denotes a number in the range 0˜1. These lithium-metal complex oxides may be used alone or in a mixture of two or more of them as the active material for the positive electrode. The lithium-metal complex oxide containing active material is preferably one or more of lithium-manganese containing complex oxide, lithium-nickel containing complex oxide, and lithium-cobalt containing complex oxide, which have layered structure or spinel structure. In view of cost reduction, the lithium-metal complex oxide containing active material is more preferably one or more of lithium-manganese containing complex oxide and lithium-nickel containing complex oxide, which have layered structure or spinel structure.

The active material for negative electrode is not particularly restricted in the material construction as long as it is capable of incorporating lithium ions during charging and releasing lithium ions during discharging, and any known material construction may be used. For example, lithium metal, graphite or carbonaceous material such as amorphous carbon, or the like, may be used. In particular, carbonaceous material is preferably used. Carbonaceous material can be made to have relatively large specific surface area, and the rate of incorporation and release of lithium can be made large so that good characteristics in charging and discharging at large current and in power output/regeneration energy density can be obtained. Especially in view of the balance of power output/regeneration energy density, carbonaceous material having relatively large voltage change associated with charging and discharging is preferably used. A higher efficiency in charging and discharging and better cycle property can be obtained by using such carbonaceous material as the active material for the negative electrode.

When this electrode is used for a positive electrode, known additives such as a conductive material or the like may be added. Aluminium or stainless steel, for example, may be used as the current collector for the positive electrode, and copper, nickel or steel, processed into punched metal, foam metal or a plate of laminated foils, for example, may be used as the current collector for the negative electrode.

This electrode can be manufactured, when the binder as described in \mathring{3} above is used, by the method of manufacturing an electrode for a lithium secondary battery to be described below, or can be manufactured by a general method (a method in which a paste formed by dispersing or dissolving the active material and the binder together with other additives as necessary in a suitable solvent, is coated to a current collector and dried, and then is subjected to pressing or the like: a method nearly same as the method of forming electrode composite material in the method of manufacturing an electrode to be described below).

(Method of Manufacturing an Electrode for a Lithium Secondary Battery)

This method of manufacturing an electrode for a lithium secondary battery can be advantageously applied to the manufacture of an electrode using the binder \mathring{3} described above in the section on the electrode for a lithium secondary battery. This manufacturing method comprises an electrode composite material forming step and a dissolving step.

The electrode composite material forming step is a step wherein an electrode composite material layer is formed having an active material and a binder having soluble dispersion dispersed therein and covering the surface of the active material. The electrode composite material layer can be formed on a current collector. The active material is the same as has been described above in the section on the electrode for a lithium secondary battery, and the binder is the same as has been described in \mathring{3} above of the section on the electrode for a lithium secondary battery and, therefore, a further description thereof is omitted here. The soluble dispersion used in the binder can be removed from the interior of the battery, so that even a compound that is undesirable to be mixed into the interior of the battery can be used.

The electrode composite material layer can be formed by a method, for example, in which a paste formed by dispersing or dissolving the active material and the binder together with additives added as required in a suitable solvent (such as water) is coated to a current collector, and then the solvent is evaporated. More specifically, the paste may be coated to the current collector in various coating methods using, for example, a die coater, a comma coater, a reverse roll, a doctor blade, or the like. Then, density of the electrode composite material layer can be increased by pressing or the like.

The dissolving step is a step in which the soluble dispersion is dissolved in a suitable solvent. The dissolved soluble dispersion is extracted into the solvent. In this step, a dissolving rate can be increased by carrying out under elevated temperature. The solvent is not mixed into the battery, and a suitable solvent can be chosen without taking a cell reaction into account.

(Lithium Secondary Battery)

A lithium secondary battery according to the present invention comprises a positive and a negative electrodes, a separator sandwiched by the positive and negative electrodes, and non-aqueous electrolyte. At least one, preferably both, of the positive and negative electrodes uses the electrode for a lithium secondary battery as described above.

This battery is not particularly restricted with respect to its shape, and may be used as a coin-type, cylinder-shaped, prism-shaped battery, or in various other shapes. In the present embodiment, the description is based upon a cylinder-shaped lithium secondary battery.

The lithium secondary battery of the present embodiment has sheet-shaped positive and negative electrodes which are laminated via a separator and are wound and rolled many times to form a roll, and contained, together with non-aqueous electrolyte filling the gaps, in a predetermined case. The positive electrode and the negative electrode are connected to positive electrode terminal and negative electrode terminal, respectively.

The non-aqueous electrolyte is an organic solvent having a supporting salt dissolved therein.

The organic solvent is not particularly restricted as long as it is used for non-aqueous electrolyte in a typical lithium secondary battery, and carbonates, halogenated hydrocarbon, ethers, ketones, nitrites, lactones, and oxorane compounds, for example, may be used. In particular, propylene carbonate, ethylene carbonate, 1,2-dimethoxyethane, dimethyl carbonate, diethyl carbonate, ethylmethyl carbonate, and a mixture solvent thereof are suitable.

Among these exemplary organic solvents, in particular, one or more non-aqueous solvent selected from the group consisting of carbonates and ethers may be preferably used in view of solubility of the supporting salt, excellent dielectric constant and viscosity, and high charging and discharging efficiency of the battery.

The supporting salt is not particularly restricted in type, and is preferably one of an inorganic salt selected from LiPF₆, LiBF₄, LiClO₄, LiAsF₆, and a derivative of these inorganic salts, an organic salt selected from LiSO₃CF₃, LiC(SO₃CF₃)₂, LiN(SO₃CF₃)₂, LiN(SO₂C₂F₅)₂, and LiN(SO₂CF₃)(SO₂C₄F₉), and a derivative of these organic salts.

By using these supporting salts, an excellent battery performance can be obtained, and the high battery performance can be maintained in temperature range other than room temperature. Concentration of the supporting salts is not particularly restricted, and is preferably chosen suitably depending upon the application taking into account the types of the supporting salt and the organic solvent.

The separator serves to electrically insulate the positive electrode from the negative electrode and to hold the non-aqueous electrolyte. For example, a porous film of synthetic resin, such as a porous film of polyolefin polymer (polyethylene, polypropylene) may be used. The size of the separator is preferably larger than that of the positive and negative electrodes in order to ensure adequate insulation between the positive and negative electrodes.

The case is not particularly restricted, and may be formed in any known shape from a known material.

A gasket is provided to ensure electrical insulation between the case and the positive and negative electrodes, and also good sealability of the case. It may be constructed from a polymer such as polypropylene that is chemically and electrically stable to the non-aqueous electrolyte.

(Method of Manufacturing a Lithium Secondary Battery)

The method of manufacturing a lithium secondary battery according to the present embodiment comprises, after a battery is manufactured using a known manufacturing method of a lithium secondary battery, a warming step of warming the battery up to or above a temperature at which the non-aqueous electrolyte swells or dissolves the portion of the polyether structure.

The known manufacturing method of a lithium secondary battery may be a method in which the positive and negative electrodes are laminated via a separator, and are placed into a battery case, and non-aqueous electrolyte is poured into the battery case to be closed and sealed.

Suitable values of temperature and duration of the warming step may vary depending upon types of the binder and the non-aqueous electrolyte used. The temperature and duration of the warming step must be chosen such that the hydrophilic binder or the hydrophilic portion of the hydrophilic-electrolytephilic binder is not dissolved and the elecrolyte-philic binder or the elecrolyte-philic portion of the hydrophilic-electrolytephilic binder is dissolved or swollen. When the polyether structure portion is polyethylene oxide, suitable warming temperature is about 40˜80° C.

The warming step is preferably performed with the battery charged at a voltage of 4.1 V or higher.

### EXAMPLE 1

A lithium secondary battery is fabricated in Example 1. The lithium secondary battery fabricated in the Example is shown in FIG. 1.

The cylindrical lithium secondary battery 100 comprises a positive electrode 1 which has an active material containing lithium for positive electrode and is capable of releasing lithium ion at the time of charging and incorporating lithium ions at the time of discharging, a negative electrode 2 which has an active material containing carbon for negative electrode and is capable of incorporating lithium ion at the time of charging and releasing lithium ions at the time of discharging, non-aqueous electrolyte 3 formed by dissolving supporting salt containing lithium in an organic solvent, and a separator 4 disposed between the positive electrode and the negative electrode.

The positive electrode 1 is an electrode formed in the shape of a sheet and comprising a positive electrode current collector 11 consisting of aluminium foil, a positive electrode composite material layer 12 having a positive electrode active material consisting of LiCoO₂ and a binder formed on the surface of the positive electrode current collector 11, and a positive electrode current collecting lead 13 joined to the positive electrode current collector.

The negative electrode is an electrode formed in the shape of a sheet and comprising a negative electrode current collector 21 consisting of copper foil, a negative electrode composite material layer 22 having a negative electrode active material and a binder formed on the surface of the negative electrode current collector 21, and a negative electrode current collecting lead 23 joined to the negative electrode current collector 21.

The positive electrode 1 and the negative electrode 2 are wound via a sheet-shaped separator 4 and are held in a case 7. The current collecting leads 13, 23 for the positive electrode 1 and the negative electrode 2 are connected, respectively, to a positive electrode terminal 5 and negative electrode terminal 6 of the case 7.

As the separator 4, a micro-porous polyethylene film of 25 μm in thickness was used.

As the electrolyte, solution formed by dissolving 1 mol/L of LiPF₆ in a solvent mixture of ethylene carbonate (EC) and diethyl carbonate (DEC) in the ratio of 3:7 in volume, was used.

Each constituent of the lithium secondary battery in the Example was fabricated in the following procedure.

(Fabrication of the Positive Electrode)

87 wt % of lithium nickel oxide as the positive electrode active material, 10 wt % of acetylene black (product number: HS-100) as the conducting filler material, and 2 wt % concentration of carboxymethyl cellulose sodium salt water were mixed to obtain 1 wt % of solid content of carboxymethyl cellulose-sodium as the hydrophilic binder, and 1 wt % of polyethylene oxide powder as the electrolyte-philic binder and a predetermined amount of water were further mixed and stirred for 1 hour with a biaxial mixer. Thereafter, PTFE aqueous dispersion having about 50% solid content as other binder was added so as to obtain 1 wt % of PTFE solid content, and the mixture was stirred for 30 minutes with a vacuum emulsifying mixer. The paste obtained in this manner was coated to both surface of an aluminium foil using a comma coater in an amount of 6.51 (mg/cm²) per surface. Then, the electrode was passed through a roll press under the load of linear pressure 740 (kg/cm) to increase the electrode density to 2.20 (g/cm³). Then, the electrode was cut to a strip of 5.4 (cm) in width and 86 (cm) in length, and the electrode composite material was scraped for the length of 2.5 (cm) as a lead tab welding portion to extract electric current. Thus, the effective reaction surface area of this electrode is 5.4 (cm)×83.5 (cm)×2=901.8 (cm²).

(Fabrication of the Negative Electrode)

For the negative electrode, 92.5 wt % of flake graphite as the negative electrode active material and 7.5 wt % of PVDF as the binder were used. A paste obtained by dispersing the graphite in a solution dissolving PVDF in N-methyl-2-pyrrolidone was coated to both surfaces of a copper foil using a comma coater in an amount of 3.74 (mg/cm²) per surface, and then was passed through a roll press under the load of linear pressure 250 (kg/cm) to increase the electrode density to 1.25 (g/cm³) to obtain the negative electrode. Then, the electrode was cut to a strip of 5.6 (cm) in width and 90.5 (cm) in length, and the electrode composite material was scraped for the length of 0.5 (cm) as a lead tab welding portion to extract an electric current. Thus, the effective reaction surface area of this electrode is 5.6 (cm)×90 (cm)×2=1008 (cm²).

(Assembling the Battery)

The sheet-shaped positive electrode and the sheet-shaped negative electrode obtained as described above were laminated and wound with a separator therebetween to form the wound electrode roll. Polyethylene of 25 μm in thickness was used as the separator. The obtained wound electrode roll was inserted into a case and held in it. The current collecting leads having one end thereof welded to the lead tab welding portion of the sheet-shaped positive electrode and the sheet-shaped negative electrode was joined to the positive electrode terminal and the negative electrode terminal of the case, respectively. Then, the electrolyte was poured into the case holding the wound electrode roll, and the case was closed and sealed.

A cylindrical lithium secondary battery of 18 mm in diameter and 65 mm in axial length was fabricated in the procedure as described above, and various characteristics of the lithium secondary battery were measured by the measuring method as described below.

(Initial Capacity of the Battery)

First, the battery was charged with charging current of 250 (mA) to 4.1 (V) under the conditions of CC-CV, and was discharged with discharging current of 333 (mA) to 3.0 (V) under the condition of CC. Then, after the battery was charged with charging current of 1000 (mA) to 4.1 (V) under the conditions of CC-CV, and was discharged four times with discharging current of 1000 (mA) to 3.0 (V) under the condition of CC, which charge-discharge was cycled four times, the battery was charged with charging current of 1000 (mA) to 4.1 (V) under the conditions of CC-CV, and was discharged with discharging current of 1000 (mA) to 3.0 (V) under the condition of CC, and the discharge capacity measured at this time was taken as the initial capacity of the battery. Measurement was performed in an atmosphere at the temperature of 25° C.

(Power Output at Room Temperature)

After the measurement of the initial discharge capacity of the battery, the battery was maintained at 25° C., and was charged with charging current of 1000 mA to 3.750 V (SOC 60%) under the conditions of CC-CV.

Then, the battery was discharged for 10 seconds and charged for 10 seconds repeatedly with the currents of 300 mA, 900 mA, 2.7 A, 5.4 A, 8.1 A, respectively, in this order, and respective current values and closed circuit battery voltages were approximated by a straight line, and the current value at the intersection of the straight line with the voltage of 3.0 V was read. This current value was multiplied by 3 V to obtain the power output. All the measurements were performed at 25° C.

(Power Output at Low Temperature)

After the measurement of the initial discharge capacity of the battery, the battery was maintained at 25° C., and was charged with charging current of 1000 mA to 3.618 V (SOC 40%) under the conditions of CC-CV.

Then, the battery was discharged for 10 seconds and charged for 10 seconds repeatedly with currents of 100 mA, 200 mA, 300 mA, 400 mA, 600 mA, 1000 mA, respectively in this order, and the current value at the intersection of the straight line connecting two points above and below 3.0 V with the voltage of 3.0 V was read. This current value was multiplied by 3 V to obtain the power output. All the measurements were performed at −30° C.

(Evaluation of Cycle Property at High Temperature)

After the initial capacity of the battery was evaluated, the battery was maintained at a constant temperature of 60° C. in a thermostat, and was repeatedly charged and discharged with a constant current of 2.2 mA/cm² between the battery inter-electrode voltage of 4.1 V and 3 V, and the post-cycling capacity retention, that is, ratio of the discharge capacity at 500th cycle to the discharge capacity at the 1st cycle, was calculated.

(Results)

It was found that the initial capacity of the battery was 926 mAh, the power output at room temperature was 37.1 W, and the power output at low temperature was as much as 1.60 W. A good value of 81.8% was obtained for the post-cycling capacity retention.

### EXAMPLE 2

The battery was the same as in Example 1 except that content of carboxymethyl cellulose was 0.5 wt % and content of the positive electrode active material was 87.5 wt % in the positive electrode. Due to the decrease of the content of the carboxymethyl cellulose, influence of PEO as a lithium ion conducting polymer became more pronounced. It was found that, although the initial capacity of the battery was 925 mAh and the power output at room temperature was 37.3 W, almost the same as before, the power output at low temperature was increased to 2.20 W. Good value of 81.5% was obtained for the post-cycling capacity retention.

### EXAMPLE 3

The battery was the same as in Example 1 except that content of carboxymethyl cellulose was 2 wt % and content of the positive electrode active material was 86 wt % in the positive electrode. It was found that, although the initial capacity of the battery was 925 mAh and the power output at room temperature was 37.1 W, almost the same as before, the power output at low temperature was improved to 0.95 W. A good value of 81.6% was obtained for the post-cycling capacity retention.

### EXAMPLE 4

The battery was the same as in Example 1 except that content of carboxymethyl cellulose was 3 wt % and content of the positive electrode active material was 85 wt % in the positive electrode. It was found that, although the initial capacity of the battery was 925 mAh and the power output at room temperature was 37.3 W, almost the same as before, the power output at low temperature was improved to 0.90 W. Good value of 81.5% was obtained for the post-cycling capacity retention.

### EXAMPLE 5

The battery was the same as in Example 1 except that, in place of the polyethylene oxide as electrolyte-philic binder, 2 wt % of carboxymethyl cellulose having the carboxy group substituted by a functional group of polyethylene oxide structure was used as a hydrophilic-electrolytephilic binder polymer in the positive electrode. By providing a portion of locally high lithium conductivity in a polymer, same effect can be obtained as mixing two types of polymers. It was found that, although the initial capacity of the battery was 924 mAh and the power output at room temperature was 37.2 W, almost the same as before, the power output at low temperature was improved to 2.10 W. A good value of 80.5% was obtained for the post-cycling capacity retention.

### EXAMPLE 6

In the positive electrode in Example 1, 20% of LiN(C₂F₅SO₂)(C₂F₅SO₂) based on solid content of carboxymethyl cellulose was mixed in aqueous solution of carboxymethyl cellulose to fabricate a battery. This was a binder having LiN(C₂F₅O₂)(C₂F₅SO₂) as soluble dispersion mixed and dispersed in carboxymethyl cellulose as a polymer matrix. In this battery, after non-aqueous electrolyte was poured into the case, LiN(C₂F₅SO₂)(C₂F₅SO₂) is extracted from CMC coating and lithium ion conductivity is thereby improved. As a result, it was found that, although the initial capacity of the battery was 926 mAh and the power output at room temperature was 37.3 W, almost the same as before, the power output at low temperature was improved to 1.20 W. A good value of 81.3% was obtained for the post-cycling capacity retention.

### EXAMPLE 7

After the battery in Example 1 was fabricated and initial discharge capacity was measured (3.0 V), it was maintained at 60° C. a thermostat for 24 hours for aging (warming step). This was used as the battery in Example 7. By aging, the polyethylene oxide as the binder was dissolved in the non-aqueous electrolyte, and lithium ion conductivity of the electrode was thereby improved. As a result, although the initial capacity of the battery was 926 mAh and the power output at room temperature was 37.3 W, almost the same as before, the power output at low temperature was improved to 2.30 W. Good value of 81.6% was obtained for the post-cycling capacity retention.

### EXAMPLE 8

After the battery in Example 1 was fabricated and initial discharge capacity was measured, it was further charged to 4.1 V and thereafter maintained at 60° C. in a thermostat for 24 hours for aging, and was used as the battery in Example 8. By aging, the polyethylene oxide as the binder was dissolved in the non-aqueous electrolyte, and lithium ion conductivity of the electrode was thereby improved. As a result, although the initial capacity of the battery was 926 mAh and the power output at room temperature was 37.3 W, almost the same as before, the power output at low temperature was improved to 2.60 W. A good value of 81.7% was obtained for the post-cycling capacity retention.

### EXAMPLE 9

The battery was the same as in Example 1 except that content of carboxymethyl cellulose was 1.9 wt % and content of the positive electrode active material was 86.1 wt %. Although the initial capacity of the battery was 925 mAh and the power output at room temperature was 37.1 W, almost the same as before, the power output at low temperature was 1.00 W and was improved compared to the battery in Comparative examples. A good value of 81.5% was obtained for the post-cycling capacity retention.

### EXAMPLE 10

The battery was the same as in Example 1 except that content of polyethylene oxide powder was 0.3 wt % and content of the positive electrode active material was 87.7 wt %. Although the initial capacity of the battery was 926 mAh and the power output at room temperature was 37.1 W, almost the same as before, the power output at low temperature was 0.92 W and was improved compared to the battery in Comparative examples. A good value of 81.6% was obtained for the post-cycling capacity retention.

### EXAMPLE 11

The battery was the same as in Example 1 except that content of polyethylene oxide powder was 0.7 wt % and content of the positive electrode active material was 87.3 wt %. Although the initial capacity of the battery was 926 mAh and the power output at room temperature was 37.1 W, almost the same as before, the power output at low temperature was 1.20 W and was improved compared to the battery in Comparative examples. A good value of 81.5% was obtained for the post-cycling capacity retention.

### EXAMPLE 12

The battery was the same as in Example 1 except that content of polyethylene oxide powder was 2 wt % and content of the positive electrode active material was 86 wt %. It was found that although the initial capacity of the battery was 926 mAh and the power output at room temperature was 37.2 W, almost the same as before, the power output at low temperature was 2.00 W and was improved compared to the battery in Comparative examples. A good value of 81.4% was obtained for the post-cycling capacity retention.

### EXAMPLE 13

The battery was the same as in Example 3 except that content of polyethylene oxide powder was 3 wt % and content of the positive electrode active material was 85 wt %. It was found that although the initial capacity of the battery was 925 mAh and the power output at room temperature was 37.2 W, almost the same as before, the power output at low temperature was 2.10 W and was improved compared to the battery in Comparative examples. A good value of 81.4% was obtained for the post-cycling capacity retention.

### EXAMPLE 14

The battery was the same as in Example 1 except that content of PTFE was 0 wt % and content of the positive electrode active material was 88 wt %. It was found that although the initial capacity of the battery was 925 mAh and the power output at room temperature was 37.1 W, almost the same as before, the power output at low temperature was 1.60 W and was improved compared to the battery in Comparative examples. A good value of 81.5% was obtained for the post-cycling capacity retention.

### EXAMPLE 15

The battery was the same as in Example 1 except that content of carboxymethyl cellulose (CMC) was 2 wt %, content of PTFE was 0 wt % and content of the positive electrode active material was 87 wt %. It was found that although the initial capacity of the battery was 925 mAh and the power output at room temperature was 37.1 W, almost the same as before, the power output at low temperature was 0.95 W and was improved compared to the battery in Comparative examples. A good value of 81.4% was obtained for the post-cycling capacity retention.

### EXAMPLE 16

The battery was the same as in Example 1 except that methyl cellulose was adopted in place of CMC. It was found that although the initial capacity of the battery was 925 mAh and the power output at room temperature was 37.1 W, almost the same as before, the power output at low temperature was 1.55 W and was improved compared to the battery in Comparative examples. A good value of 81.6% was obtained for the post-cycling capacity retention.

### EXAMPLE 17

The battery was the same as in Example 9 except that methyl cellulose was adopted in place of CMC in the positive electrode in Example 9. It was found that although the initial capacity of the battery was 925 mAh and the power output at room temperature was 37.3 W, almost the same as before, the power output at low temperature was 0.99 W and was improved compared to the battery in Comparative examples. A good value of 81.5% was obtained for the post-cycling capacity retention.

### EXAMPLE 18

The battery was the same as in Example 3 except that methyl cellulose was adopted in place of CMC in the positive electrode in Example 3. It was found that although the initial capacity of the battery was 925 mAh and the power output at room temperature was 37.1 W, almost the same as before, the power output at low temperature was 0.94 W and was improved compared to the battery in Comparative examples. A good value of 81.5% was obtained for the post-cycling capacity retention.

### EXAMPLE 19

The battery was the same as in Example 1 except that cellulose acetate phthalate was adopted in place of CMC in the positive electrode in Example 1. It was found that although the initial capacity of the battery was 924 mAh and the power output at room temperature was 37.2 W, almost the same as before, the power output at low temperature was 1.50 W and was improved compared to the battery in Comparative examples. A good value of 81.6% was obtained for the post-cycling capacity retention.

### EXAMPLE 20

The battery was the same as in Example 9 except that cellulose acetate phthalate was adopted in place of CMC in the positive electrode in Example 9. It was found that although the initial capacity of the battery was 924 mAh and the power output at room temperature was 37.1 W, almost the same as before, the power output at low temperature was 0.98 W and was improved compared to the battery in Comparative examples. A good value of 81.3% was obtained for the post-cycling capacity retention.

### EXAMPLE 21

The battery was the same as in Example 3 except that cellulose acetate phthalate was adopted in place of CMC in the positive electrode in Example 3. It was found that although the initial capacity of the battery was 924 mAh and the power output at room temperature was 37.0 W, almost the same as before, the power output at low temperature was 0.93 W and was improved compared to the battery in Comparative examples. A good value of 81.6% was obtained for the post-cycling capacity retention.

### EXAMPLE 22

The battery was the same as in Example 1 except that hydroxypropylmethyl cellulose phthalate was adopted in place of CMC in the positive electrode in Example 1. It was found that although the initial capacity of the battery was 924 mAh and the power output at room temperature was 37.2 W, almost the same as before, the power output at low temperature was 1.52 W and was improved compared to the battery in Comparative examples. A good value of 81.2% was obtained for the post-cycling capacity retention.

### EXAMPLE 23

The battery was the same as in Example 9 except that hydroxypropylmethyl cellulose phthalate was adopted in place of CMC in the positive electrode in Example 9. It was found that although the initial capacity of the battery was 924 mAh and the power output at room temperature was 37.3 W, almost the same as before, the power output at low temperature was 0.98 W and was improved compared to the battery in Comparative examples. A good value of 81.3% was obtained for the post-cycling capacity retention.

### EXAMPLE 24

The battery was the same as in Example 1 except that hydroxypropylmethyl cellulose phthalate was adopted in place of CMC in the positive electrode in Example 3. It was found that although the initial capacity of the battery was 923 mAh and the power output at room temperature was 37.0 W, similar to Example 1, the power output at low temperature was 0.92 W and was improved compared to the battery in Comparative examples. A good value of 81.4% was obtained for the post-cycling capacity retention.

### Comparative Example 1

As the positive electrode active material, 87 wt % of lithium nickel oxide, 10 wt % of acetylene black (product number: HS-100) as conducting filler material, 2 wt % concentration of carboxymethyl cellulose sodium salt water were mixed to obtain 1 wt % of solid content of carboxymethyl cellulose-sodium and a predetermined amount of water were further mixed and stirred for 1 hour with a biaxial mixer. Thereafter, PTFE aqueous dispersion having about 50% solid content as other binder was added so as to obtain 1 wt % of PTFE solid content, and the mixture was stirred for 30 minutes with a vacuum emulsifying mixer. The paste obtained in this manner was coated to both surface of an aluminium foil using a comma coater in an amount of 6.51 (mg/cm²) per surface. A battery was fabricated in the same manner as in Example 1 with respect to other constituents and fabrication method. The initial discharge capacity of the battery was as high as 926 mAh, and the power output at room temperature was 37.2 W. The power output at low temperature was as low as 0.90 W. Good value of 81.4% was obtained for the post-cycling capacity retention.

### Comparative Example 2

The battery was the same as in Comparative example 1 except that content of the positive electrode active material was 88.5 wt % and content of carboxymethyl cellulose was 0.5 wt %. The initial discharge capacity of the battery was 926 mAh, the power output at room temperature was 37.1 W, and the power output at low temperature was 0.91 W. A good value of 81.4% was obtained for the post-cycling capacity retention.

### Comparative Example 3

The battery was the same as in Comparative example 1 except that content of the positive electrode active material was 87 wt % and the content of carboxymethyl cellulose was 2 wt %. The initial discharge capacity of the battery was 926 mAh, the power output at room temperature was 37.2 W, and the power output at low temperature was 0.89 W. A good value of 81.6% was obtained for the post-cycling capacity retention.

### Comparative Example 4

The battery was the same as in Comparative example 1 except that content of the positive electrode active material was 86 wt % and content of carboxymethyl cellulose was 3 wt %. The initial discharge capacity of the battery was 926 mAh, the power output at room temperature was 37.2 W, and the power output at low temperature was 0.88 W. A good value of 81.3% was obtained for the post-cycling capacity retention.

### Comparative Example 5

After the battery in Example 1 was fabricated and initial discharge capacity was measured (3.0 V), it was maintained at 25° C. in a thermostat for 24 hours for aging. This was used as the battery in the Comparative example 5. The initial discharge capacity of the battery was 926 mAh, the power output at room temperature was 37.2 W, and the power output at low temperature was 1.60 W. Thus, the power output at low temperature after the aging was the same as before the aging. A good value of 81.3% was obtained for the post-cycling capacity retention.

### Comparative Example 6

The battery was the same as in Comparative example 1 except that 86 wt % of lithium nickel oxide, 10 wt % of acetylene black (product number: HS-100) as the conducting filler material, and a paste obtained by dissolving/dispersing 4 wt % of PVDF in N-methyl-2-pyrrolidone as a binder were used in the positive electrode. The initial discharge capacity was 926 mAh, the power output at room temperature was 37.2 W, and the power output at low temperature was 1.50 W. The value of post-cycling capacity retention was 67.9%, which was lower than that of a battery using the cellulose derivative, carboxymethyl cellulose, as a binder.

### Comparative Example 7

The battery was the same as in Example 1 except that content of polyethylene oxide was 4 wt % and content of the positive electrode active material was 84 wt %. The initial discharge capacity was 900 mAh, and the power output at room temperature was 32.5 W. These values were found to be lower than those in Example 1. The power output at low temperature was 0.60 W. The value of the post-cycling capacity retention was 75.3%.

### Comparative Example 8

The battery was the same as in Comparative example 3 except that, in place of CMC, methyl cellulose was adopted in the positive electrode. The initial discharge capacity was 925 mAh, the power output at room temperature was 37.0 W, and the power output at low temperature was 0.88 W. These values were almost the same as those in Comparative example 3. A good value of 81.3% was obtained for the post-cycling capacity retention.

### Comparative Example 9

The battery was the same as in Comparative example 3 except that, in place of CMC, cellulose acetate phthalate was adopted in the positive electrode. The initial discharge capacity was 924 mAh, the power output at room temperature was 37.0 W, and the power output at low temperature was 0.87 W. These values were almost the same as those in Comparative example 3. A good value of 81.3% was obtained for the post-cycling capacity retention.

### Comparative Example 10

The battery was the same as in Comparative example 3 except that, in place of CMC, hydroxypropylmethyl cellulose phthalate was adopted in the positive electrode. The initial discharge capacity was 923 mAh, the power output at room temperature was 37.0 W, and the power output at low temperature was 0.86 W. These values were almost the same as those in Comparative example 3. A good value of 81.2% was obtained for the post-cycling capacity retention. Results are shown in Tables 1˜6.

TABLE 1

| | Content of | | | Dis- | | | |
|---|---|---|---|---|---|---|---|
| | binder | | | charge | Power | Power | Capacity |
| | (wt %) | | | capacity | output | output | retention |
| | PEO | CMC | PTFE | mAh | at room | at low | % |
| Exam- | 1 | 1 | 1 | 926 | 37.1 | 1.60 | 81.8 |
| ple 1 | | | | | | | |
| Exam- | 1 | 0.5 | 1 | 925 | 37.3 | 2.20 | 81.5 |
| ple 2 | | | | | | | |
| Exam- | 1 | 2 | 1 | 925 | 37.1 | 0.95 | 81.6 |
| ple 3 | | | | | | | |
| Exam- | 1 | 3 | 1 | 925 | 37.3 | 0.90 | 81.5 |
| ple 4 | | | | | | | |
| Com- | 0 | 1 | 1 | 926 | 37.2 | 0.90 | 81.4 |
| parative | | | | | | | |
| example | | | | | | | |
| 1 | | | | | | | |
| Com- | 0 | 0.5 | 1 | 926 | 37.1 | 0.91 | 81.4 |
| parative | | | | | | | |
| example | | | | | | | |
| 2 | | | | | | | |
| Com- | 0 | 2 | 1 | 926 | 37.2 | 0.89 | 81.6 |
| parative | | | | | | | |
| example | | | | | | | |
| 3 | | | | | | | |
| Com- | 0 | 3 | 1 | 926 | 37.2 | 0.88 | 81.3 |
| parative | | | | | | | |
| example | | | | | | | |
| 4 | | | | | | | |

TABLE 2

| | Content of | | | | Power | Power | | Aging | |
|---|---|---|---|---|---|---|---|---|---|
| | binder | | | Discharge | output | output | Capacity | Conditions | |
| | (wt %) | | | capacity | at room | at low | retention | Temper- | Battery |
| | PEO | CMC | PTFE | mAh | W | W | % | ature | voltage |
| Example 7 | 1 | 1 | 1 | 926 | 37.3 | 2.30 | 81.6 | 60° C. | 3.0 V |
| Example 8 | 1 | 1 | 1 | 926 | 37.3 | 2.60 | 81.7 | 60° C. | 4.1 V |
| Compara- | 1 | 1 | 1 | 926 | 37.2 | 1.60 | 81.8 | 25° C. | 3.0 V |
| tive exam- | | | | | | | | | |
| ple 5 | | | | | | | | | |

TABLE 3

| | Content of | | | Dis- | | | |
|---|---|---|---|---|---|---|---|
| | binder | | | charge | Power | Power | Capacity |
| | (wt %) | | | capacity | output | output | retention |
| | PEO | CMC | PTFE | mAh | at room | at low | % |
| Exam- | 1 | 1.9 | 1 | 925 | 37.1 | 1.00 | 81.5 |
| ple 9 | | | | | | | |
| Exam- | 0.3 | 1 | 1 | 926 | 37.1 | 0.92 | 81.6 |
| ple 10 | | | | | | | |
| Exam- | 0.7 | 1 | 1 | 926 | 37.1 | 1.20 | 81.5 |
| ple 11 | | | | | | | |
| Exam- | 2 | 1 | 1 | 926 | 37.2 | 2.00 | 81.4 |
| ple 12 | | | | | | | |
| Exam- | 3 | 1 | 1 | 925 | 37.2 | 2.10 | 81.4 |
| ple 13 | | | | | | | |
| Com- | 4 | 1 | 1 | 900 | 32.5 | 0.60 | 75.3 |
| parative | | | | | | | |
| example | | | | | | | |
| 7 | | | | | | | |
| Exam- | 1 | 1 | 0 | 925 | 37.1 | 1.60 | 81.5 |
| ple 14 | | | | | | | |
| Exam- | 1 | 2 | 0 | 925 | 37.1 | 0.95 | 81.4 |
| ple 15 | | | | | | | |

TABLE 4

| | Content of | | | Dis- | | | |
|---|---|---|---|---|---|---|---|
| | binder | | | charge | Power | Power | Capacity |
| | (wt %) | | | capacity | output | output | retention |
| | PEO | MC | PTFE | mAh | at room | at low | % |
| Exam- | 1 | 1 | 1 | 925 | 37.1 | 1.55 | 81.6 |
| ple 16 | | | | | | | |
| Exam- | 1 | 1.9 | 1 | 925 | 37.3 | 0.99 | 81.5 |
| ple 17 | | | | | | | |
| Exam- | 1 | 2 | 1 | 925 | 37.1 | 0.94 | 81.5 |
| ple 18 | | | | | | | |
| Com- | 0 | 2 | 1 | 925 | 37.0 | 0.88 | 81.3 |
| parative | | | | | | | |
| example | | | | | | | |
| 8 | | | | | | | |

TABLE 5

| | Content of | | | Dis- | | | |
|---|---|---|---|---|---|---|---|
| | binder | | | charge | Power | Power | Capacity |
| | (wt %) | | | capacity | output | output | retention |
| | PEO | CAP | PTFE | mAh | at room | at low | % |
| Exam- | 1 | 1 | 1 | 924 | 37.2 | 1.50 | 81.6 |
| ple 19 | | | | | | | |
| Exam- | 1 | 1.9 | 1 | 924 | 37.1 | 0.98 | 81.3 |
| ple 20 | | | | | | | |
| Exam- | 1 | 2 | 1 | 924 | 37.0 | 0.93 | 81.6 |
| ple 21 | | | | | | | |
| Com- | 0 | 2 | 1 | 924 | 37.0 | 0.87 | 81.4 |
| parative | | | | | | | |
| example | | | | | | | |
| 9 | | | | | | | |

TABLE 6

| | Content of | | | Dis- | | | |
|---|---|---|---|---|---|---|---|
| | binder | | | charge | Power | Power | Capacity |
| | (wt %) | | | capacity | output | output | retention |
| | PEO | HMCR | PTFE | mAh | at room | at low | % |
| Exam- | 1 | 1 | 1 | 924 | 37.2 | 1.52 | 81.2 |
| ple 22 | | | | | | | |
| Exam- | 1 | 1.9 | 1 | 924 | 37.3 | 0.98 | 81.3 |
| ple 23 | | | | | | | |
| Exam- | 1 | 2 | 1 | 923 | 37.0 | 0.92 | 81.4 |
| ple 24 | | | | | | | |
| Com- | 0 | 2 | 1 | 923 | 37.0 | 0.86 | 81.2 |
| parative | | | | | | | |
| example | | | | | | | |
| 10 | | | | | | | |

[Considerations]

It has been revealed that values of initial discharge capacity and power output at room temperature were almost the same in all Examples and Comparative examples except Comparative example 7, and that the type of binder does not significantly affect the values of initial discharge capacity and power output at room temperature. It appears that, in the battery of Comparative example 7, polyethylene oxide as an electrolyte-philic binder was contained in excess of 3 wt % (4%) so that effect of binder was not fully exhibited. Therefore, it has been revealed that the suitable content of an electrolyte-philic binder relative to the total mass of the electrode composite material layer is preferably less than 4%, and more preferably 3 wt % or less.

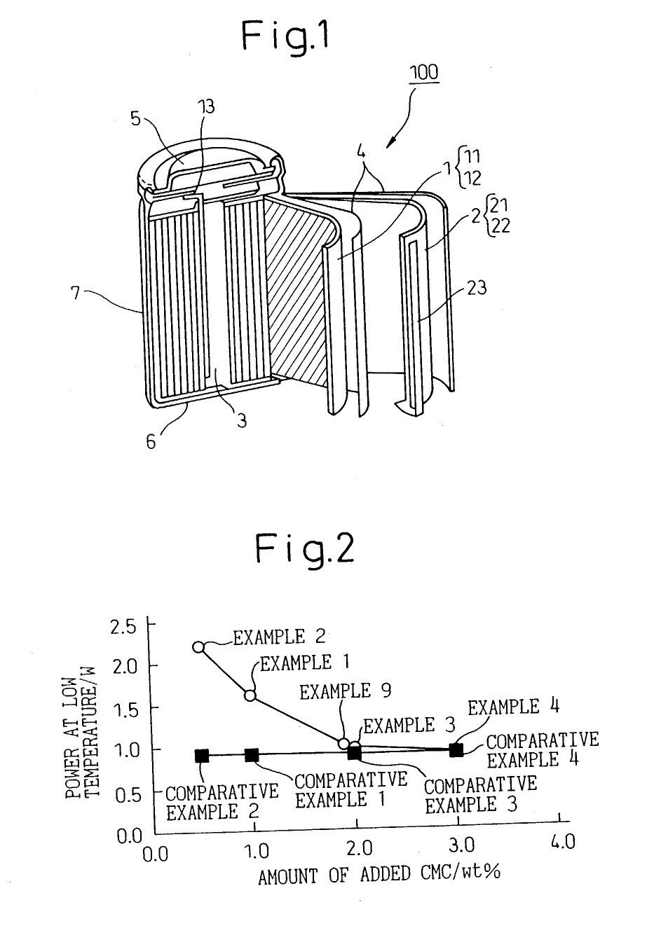

It has been found that, as is evident from comparison of Examples 1˜4, 9 and Comparative examples 1˜4 as shown in FIG. 2, power output at low temperature is increased by adding an electrolyte-philic binder as an additional binder. In particular, when carboxymethyl cellulose was added in an amount of 2 wt % or less, value of power output of the battery at low temperature was remarkably improved. When carboxymethyl cellulose was added in an amount of 1 wt % or less, the value of power output at low temperature could be reliably improved.

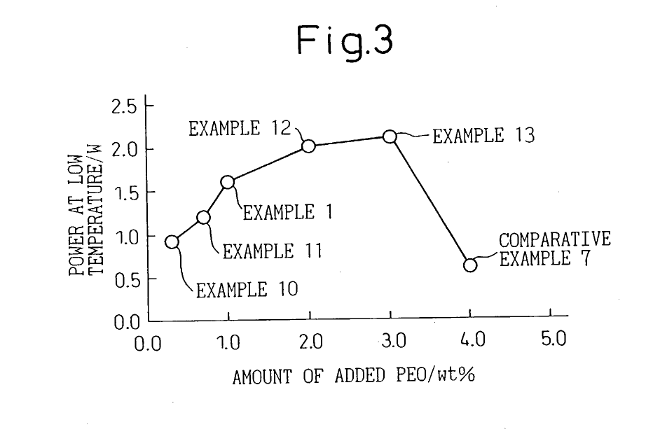

It has been revealed that, as is evident from comparison of Examples 1, 10˜13, and Comparative example 7 as shown in FIG. 3, PEO as an electrolyte-philic binder is added preferably in an amount of less than 4 wt %, and more preferably 3 wt % or less, relative to the total mass of the electrode composite material layer in order to reliably increase power output at low temperature.

From the result of power output at low temperature in Examples 14 and 15 which did not contain PTFE, it has become evident that it does not produce much influence on power output at low temperature whether or not PTFE is contained as a binder.

From the result on batteries using methyl cellulose as a hydrophilic binder (Examples 16˜18, and Comparative example 8), and batteries using cellulose acetate phthalate as a hydrophilic binder (Examples 19˜21, and Comparative example 9), and batteries using hydroxypropylmethyl cellulose phthalate as a hydrophilic binder (Examples 22˜24, and Comparative example 10), it has become evident that cellulose derivatives other than carboxymethyl cellulose may be used effectively as a hydrophilic binder to improve power output at low temperature. As is evident from the result of Examples 5 and 6, the same effect was obtained by addition of a hydrophilic-electrolytephilic binder or by adopting a binder having dispersed soluble dispersion. When an electrolyte-philic binder was used alone, a slurry that is required for forming an electrode could not be obtained, and therefore, a battery could not be fabricated.

Further, it has been found that, as is evident from the result of Example 7 and 8, compared with that of Comparative example 5 in which aging was performed at 25° C., value of power output at low temperature was further improved by warming step (aging) at about 60° C. The effect of the warming step was increased by charging the battery before the warming step.

It has been found, as a result of comparison of Example 1 and Comparative example 1 with Comparative example 6, that cycle property was improved by using a hydrophilic binder in place of conventional PVDF, or by addition of a hydrophilic-electrolytephilic binder.

As has been described in the foregoing, in an electrode for a lithium secondary battery or in a lithium secondary battery, by providing the electrode with a binder having a hydrophilic portion and an electrolyte-philic portion, the power output at low temperature can be improved while retaining the effect upon improvement of cycle property derived from the hydrophilic portion.

The power output at low temperature can be further improved by adopting a method of manufacturing a lithium secondary battery comprising a warming step.

What is claimed is:

1. An electrode for a lithium secondary battery having an electrode composite material layer comprising an active material and a binder which contains a hydrophilic binder consisting of a cellulose derivative and an electrolyte-philic binder containing a polyether structure in the chemical structure and which covers the surface of the active material.

2. An electrode for a lithium secondary battery according to claim 1, wherein said hydrophilic binder is carboxymethyl cellulose.

3. An electrode for a lithium secondary battery according to claim 1, wherein said electrolyte-philic binder is polyethylene oxide.

4. An electrode for a lithium secondary battery according to claims 1, wherein content of said electrolyte-philic binder relative to said electrode composite material layer is 3 wt % or less.

5. An electrode for a lithium secondary battery having an electrode composite material layer comprising an active material and a binder which contains a block-type hydrophilic-electrolytephilic binder consisting of a cellulose derivative which has a grafted electrolyte-philic side chain consisting of a polyether structure and which covers the surface of the active material.

6. An electrode for a lithium secondary battery according to claim 5, wherein said block-type hydrophilic-electrolytephilic binder has an a binder which has ether linkage of carboxymethyl cellulose and polyethylene oxide.

7. An electrode for a lithium secondary battery according to any one of claim 1 or 5, wherein content of said cellulose derivative relative to said electrode composite material layer is 2 wt % or less.

8. An electrode for a lithium secondary battery having an electrode composite material layer comprising an active material and a binder which has dispersed soluble dispersion soluble in non-aqueous electrolyte and which covers the active material.

9. An electrode for a lithium secondary battery according to claim 8, wherein said soluble dispersion is lithium salt.

10. A lithium secondary battery comprising a positive and a negative electrodes, a separator sandwiched between the positive and negative electrodes, and non-aqueous electrolyte, characterized in that at least one of the positive and negative electrodes is the electrode for a lithium secondary battery according to any one of claim 1, 5 or 8.

11. A method of manufacturing a lithium secondary battery comprising a positive and a negative electrode, a separator sandwiched between the positive and negative electrodes, and non-aqueous electrolyte, wherein at least one of the positive and negative electrodes is an electrode for a lithium secondary battery having an electrode composite material layer comprising an active material and a binder which contains a hydrophilic binder consisting of cellulose derivative and an electrolyte-philic binder containing polyether structure in chemical structure and which covers the surface of the active material, characterized in that said method comprises a warming step of warming up to and above the temperature at which said non-aqueous electrolyte swells or dissolves said polyether structure portion.

12. A method of manufacturing a lithium secondary battery according to claim 11, wherein said hydrophilic binder is carboxymethyl cellulose.

13. A method of manufacturing a lithium secondary battery according to claim 11, wherein said electrolyte-philic binder is polyethylene oxide.

14. A method of manufacturing a lithium secondary battery according to claims 11, wherein content of said electrolyte-philic binder relative to said electrode composite material layer is 3 wt % or less.

15. A method of manufacturing a lithium secondary battery comprising a positive and a negative electrodes, a separator sandwiched between the positive and negative electrodes, and non-aqueous electrolyte, wherein at least one of the positive and negative electrodes has an electrode composite material layer comprising an active material and a binder which contains a block-type hydrophilic-electrolytephilic binder consisting of a cellulose derivative having a grafted electrolyte-philic side chain consisting of polyether structure, characterized in that said method comprises a warming step of warming up to and above the temperature at which said non-aqueous electrolyte swells or dissolves said polyether structure portion.

16. A method of manufacturing a lithium secondary battery according to claim 15, wherein said block-type hydrophilic-electrolytephilic binder is a ester of carboxymethyl cellulose and polyethylene oxide.

17. A method of manufacturing a lithium secondary battery according to any one of claim 11 or 15, wherein content of said cellulose derivative relative to said electrode composite material layer is 2 wt % or less.

18. A method of manufacturing a lithium secondary battery according to any one of claim 11 or 15, wherein said warming step is performed after said lithium secondary battery is charged up to or above 4.1 V.

19. A method of manufacturing a lithium secondary battery comprising an electrode composite material layer forming step of forming an electrode composite material layer having an active material and a binder which has dispersed soluble dispersion and covers the surface of the active material, and a dissolving step of dissolving and removing the soluble dispersion by soaking said electrode composite material in a solvent capable of dissolving said soluble dispersion.

20. A method of manufacturing a lithium secondary battery according to claim 19, wherein said soluble dispersion is lithium salt.
